(19) United States
(12) Patent Application Publication
(10) Pub. No.: US 2011/0061004 A1
(43) Pub. Date: Mar. 10, 2011

(54) Use of Communicator Application to Establish Communication with Experts

(75) Inventors: Ashutosh Tripathi, Hyderabad (IN); Nagesh Pabbisetty, Hyderabad (IN); Dharmanand Singh, Hyderabad (IN)

(73) Assignee: MICROSOFT CORPORATION, Redmond, WA (US)

(21) Appl. No.: 12/554,591

(22) Filed: Sep. 4, 2009

(51) Int. Cl. G06F 3/048; G06F 15/16; G06F 17/30

(52) U.S. Cl. 715/753; 709/203; 715/758; 715/756; 707/E17.108; 709/204

(57) ABSTRACT

A system is provided for using a communicator application to identify experts and to establish communication with experts. A computing device in the system causes a display device to display a graphical user interface (GUI) of the communicator application to a first user. The communicator application is an application that initiates communication sessions between users. Subsequently, the computing device receives search input via the GUI. The search input indicates a type of expertise. After the computing device receives the search input, the computing device causes the display device to display a user identifier within the GUI, the user identifier identifying a second user. The second user possesses the type of expertise indicated by the search input.

### BACKGROUND

In today's economy, it is important to be able to take advantage of the knowledge of others effectively. For instance, a first person may not know much about computer programming, but may need to know some basic information about computer programming. In this instance, it may be valuable to the first person to be able to contact a colleague who has expertise in computer programming.

In a small organization, everybody may know each other's types of expertise. However, in a large organization, it may be difficult for individuals to know which ones of their colleagues have particular types of expertise. Moreover, in a large organization, even if an individual is able to discover the name of a colleague who has a particular type of expertise, the individual may not personally know the colleague. As a result, the individual may be disinclined to ask the colleague a question and the colleague may be disinclined to answer a question from the individual.

### SUMMARY

A system is provided for using a communicator application to identify experts and to establish communication with experts. A computing device in the system causes a display device to display a graphical user interface (GUI) of the communicator application to a first user. The communicator application is an application that initiates communication sessions between users. Subsequently, the computing device receives search input via the GUI. The search input indicates a type of expertise. After the computing device receives the search input, the computing device causes the display device to display a user identifier within the GUI. The user identifier identifies a second user. The second user possesses the type of expertise indicated by the search input.

This summary is provided to introduce a selection of concepts in a simplified form. These concepts are further described below in the Detailed Description. This summary is not intended to identify key features or essential features of the claimed subject matter, nor is this summary intended as an aid in determining the scope of the claimed subject matter.

### BRIEF DESCRIPTION OF THE DRAWINGS

FIG. 1 is a block diagram illustrating an example system for using a communicator application to identify experts and to establish communication sessions with the experts.

FIG. 2 is a block diagram illustrating logical components in an example implementation of a communication server.

FIG. 3 is a block diagram illustrating logical components in an example implementation of a client device.

FIG. 4 is a flowchart illustrating an example operation to use the communicator application to establish a communication session with an expert.

FIG. 5 is a flowchart illustrating an example operation to identify user chains that link a user to experts.

FIG. 6 is a block diagram illustrating logical components in another example implementation of the communication server.

FIG. 7 is a block diagram illustrating logical components in an example implementation of another client device.

FIG. 8 is a flowchart illustrating another example operation to use the communicator application to establish a communication session with an expert.

FIG. 9 is a diagram illustrating an example graphical user interface of the communicator application.

FIG. 10 is a diagram illustrating example physical components of an electronic computing device.

### DETAILED DESCRIPTION

As briefly described above, embodiments of the present invention are directed to the use of a communicator application to identify experts and to establish communication with the experts. Example embodiments of the present invention are described with reference to the attached figures. In the following description, reference numbers refer to like reference numbers in the attached figures. It should be understood that the attached figures are examples and are provided for purposes of explanation only.

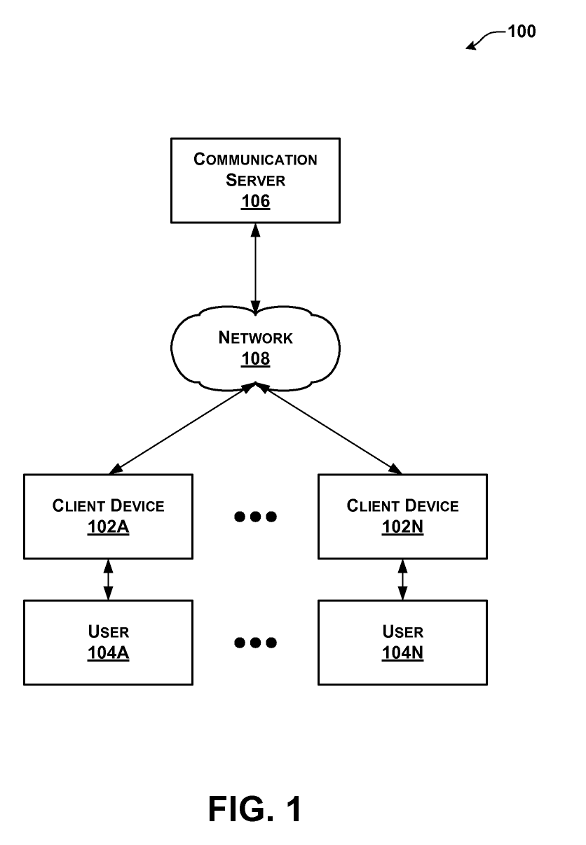

FIG. 1 is a block diagram illustrating an example system 100 for using a communicator application to identify experts and to establish communication sessions with the experts. It should be appreciated that the system 100 is merely an example. For instance, other systems may include more or fewer computing systems than those shown in the example of FIG. 1.

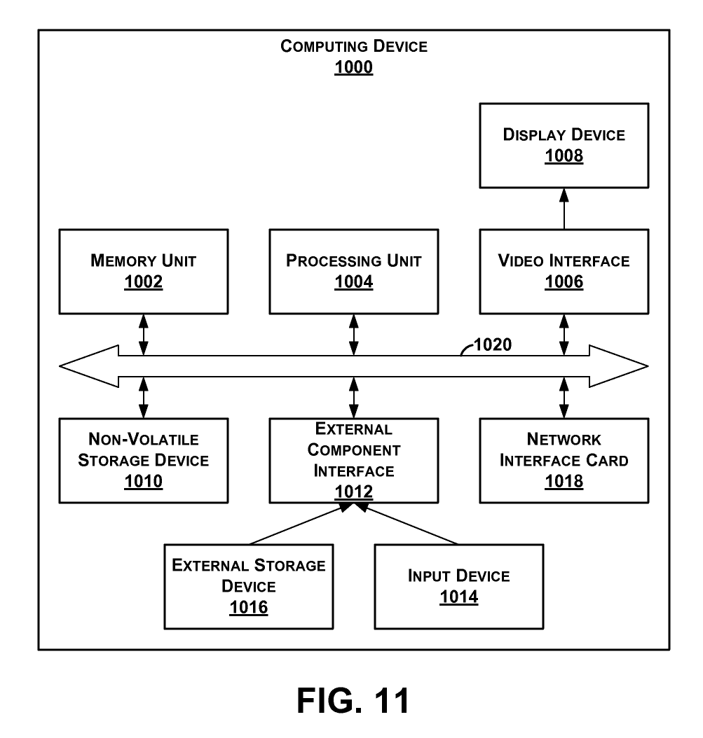

As illustrated in the example of FIG. 1, the system 100 comprises client devices 102A-102N (collectively, “client devices 102”). The client devices 102 are electronic computing devices. As used in this patent document, electronic computing devices include physical machines that use electronic components to perform computing tasks. Electronic components include physical entities that affect electrons or fields of electrons in a desired manner consistent with an intended function of an electronic computing device. Example types of electronic components include transistors, capacitors, resistors, integrated circuits, and other types of physical entities that affect electrons or fields of electrons in a desired manner consistent with an intended function of an electronic computing device. An example electronic computing device is illustrated in the example of FIG. 10.

The client devices 102 may be a wide variety of different types of electronic computing devices. For example, one or more of the client devices 102 may be desktop computers, netbook computers, laptop computers, cellular telephones, smart phones, devices integrated into vehicles, wearable computing devices, point-of-sale devices, and/or other types of electronic computing devices.

The system 100 also includes users 104A-104N of a communication application (collectively, “users 104”). The users 104 are individual human beings. In some instances, each of the users 104 is a member of an enterprise. As used in this patent document, enterprises include organizations comprising one or more people. Example types of enterprises may include business organizations (e.g., corporations, partnerships, sole proprietorships, companies, professional associations, etc.), government entities (e.g., city governments, state governments, provincial governments, national governments), non-profit entities (e.g., charities, religious organizations, foundations, etc.), and other types of organizations comprising one or more people.

Each of the users 104 interact with one of the client devices 102. For instance, in the example of FIG. 1, the user 104A interacts with the client device 102A. In different instances, the users 104 interact with the client devices 102 in different ways. For example, the client device 102A may have a touch-sensitive screen and the user 104A may interact with the client device 102A using the touch-sensitive screen. In another example, the users 104 interact with the client device 102 using mice and keyboards.

In addition, the system 100 includes a communication server 106. The communication server 106 is implemented as an electronic computing system. In different implementations, the communication server 106 is implemented in different ways. In one example, the communication server 106 is implemented as a single standalone server device. In another example, the communication server 106 is implemented as a plurality of server devices.

A network 108 facilitates communication between the client devices 102 and the communication server 106. The network 108 includes a collection of computing devices and communication links between the computing devices. The network 108 may include a wide variety of different types of computing devices. For example, the network 108 may include routers, hubs, switches, firewall devices, bridge devices, and other types of computing devices. The network 108 may include a wide variety of different types of communication links. For example, the network 108 may include radio-frequency communication links, infrared communication links, copper wire communication links, fiber optic communication links, and other types of communication links. Furthermore, the network 108 may be implemented at various scales. For instance, the network 108 may be implemented as a local area network (LAN), a metropolitan area network, a wide area network, an internet, or implemented at another scale. In some implementations, the network 108 is the Internet.

In different implementations, the communication server 106 is operated by different entities. In one example, the users 104 are members of a single enterprise. In this example, the communication server 106 is operated by the enterprise. In another example, the users 104 are members of a first enterprise, but the communication server 106 is operated by a second enterprise on behalf of the first enterprise. In this example, services provided by the communications server 106 may appear to be provided by “the cloud” (i.e., the network 108).

The client device 102 and the communication server 106 interact to provide a communicator application to the users 104. The communicator application is a software application that enables the users 104 to initiate communication sessions with other ones of the users 104. Example types of communication sessions include instant messenger conversations, chat room sessions, voice calls, video calls, web meetings, and other types of communication. Software applications include software tools that users can use to perform various functionalities.

As described in detail elsewhere in this patent document, the communicator application may be implemented in many different ways. For example, the communicator application may be implemented as a software program that, when executed by the client devices 102, causes the client devices 102 to provide the communicator application to the users 104. In another example, the communicator application may be implemented as a web application. In this other example, the client devices 102 locally execute software programs that cause the client devices 102 to provide web browser applications. For instance, each of the client devices 102 may provide the Microsoft INTERNET EXPLORER web browser application, the Mozilla FIREFOX web browser application, the Google CHROME web browser application, or another web browser application. Furthermore, in this other example, the web browser applications interact with a web server at the communication server 106 to provide the communicator application to the users 104.

When a user logs in to the communicator application, the communicator application causes a display device to display a user interface of the communicator application to the user. For ease of explanation, a user interface of the communicator application is referred to herein as a communicator interface. In different implementations, the user interface of the communicator application may be a variety of different types of user interface. For instance, the communicator interface may be a graphical user interface (GUI). In another instance, the communicator interface may be a command-line interface.

In different implementations, different computing devices in the system 100 cause display devices to display the communicator interface to the users 104. In one example implementation, each of the client devices 102 locally executes a communicator client application. Execution of the communicator client application causes the client devices 102 to send signals to display devices instructing the display devices to display the communicator interface to the users 104. In another example implementation, each of the client devices 102 locally executes a web browser application. In this other example implementation, the communication server 106 sends interface data to the client devices 102 via the network 108. In this other example implementation, the web browser applications at the client devices 102 configure the client devices to use the interface data to generate the communicator interface. In this other example, the communication server 106 effectively causes the display device to display the communicator interface.

Each of the users 104 has a buddy list. A buddy list includes a set of users. Each of the users 104 may have different buddy lists. For example, the buddy list of the user 104A may include users “B,” “C,” and “D.” In this example, the buddy list of the user 104N may include users “C,” “D,” “E,” and “F.” The communicator interfaces displayed to each of the users 104 include user identifiers that identify at least some of the users on the buddy lists of the users 104. Continuing the previous example, the communicator interface displayed to the user 104A may include user identifiers that identify users “B,” “C,” and “D.” Similarly, the communicator interface displayed to the user 104B may include user identifiers that identify users “C,” “D,” “E,” and “F.”

In different implementations, user identifiers identify users in different ways. In one example, a user identifier is the real name of a user. In another example, a user identifier is a nickname of a user. In yet another example, a user identifier is a username of a user. In yet another example, a user identifier is an e-mail address of a user.

The users 104 use the user identifiers in their communicator interfaces to select users with which to initiate communicate sessions. For instance, in one example implementation, the users 104 click on user identifiers in their communicator interfaces to initiate communication sessions with users identified by the user identifiers. In different implementations, the users 104 use the communicator application to initiate a variety of different types of communication sessions. For instance, the users 104 may use the communicator application to initiate an instant message session, a chat room session, a voice communication session, a video communication session, or another type of communication session. Moreover, in some implementations, the communicator application is able to initiate multiple types of communication sessions. For example, the communicator application may be able to initiate instant message sessions and also initiate voice communication sessions.

In some implementations, the communicator interfaces also include one or more availability indicators associated with users on the buddy lists of the users 104. Availability indicators include elements that indicate whether users are available to begin communication sessions. In different implementations, the availability indicators indicate whether a user is available to begin a communication session in different ways. For instance, in one example implementation, the availability indicators indicate whether the users are currently available to begin a communication session or not currently available to begin a communication session. In another example implementation, the availability indicators are more nuanced and include more information about what the users are doing. For instance, in this other example, an availability indicator may indicate that a user is currently logged in to the communicator application, but is away from his or her desk.

Furthermore, in some example implementations, the availability indicators indicate types of communication sessions that the users are able to begin. For instance, in such implementations, an availability indicator may indicate that a user is available to begin an instant message session or a voice communication session, but not a video communication session.

One of the users 104 may need knowledge regarding a subject with which the user is unfamiliar. For ease of explanation, the one of the users 104 needing knowledge regarding a subject with which the user is unfamiliar is referred to herein as the requesting user. Furthermore, for ease of explanation, the communicator interface displayed to the requesting user is referred to herein as the communicator interface of the requesting user or the requesting user's communicator interface. For example, the requesting user may not know anything about organic chemistry, but needs to know something about organic chemistry. In this situation, the requesting user provides search input to the communicator application via the requesting user's communication interface. The search input indicates one or more types of expertise. For ease of explanation, this patent document refers to ones of the users 104 that possess the types of expertise indicated by the search input as the experts. Input is received via a communicator interface when a user uses the communicator interface to provide the input. Continuing the previous example, the requesting user may enter the phrase “organic chemistry” into the requesting user's communicator interface. In response to receiving the search input, the communicator application identifies ones of the users 104 who possess the types of expertise indicated by the search input (i.e., the experts).

If the buddy list of the requesting user includes users who possess the types of expertise indicated by the search input, the communicator application displays user identifiers that identify the experts in the requesting user's communicator interface. For example, if the communicator application determines that the buddy list of the requesting user contains a user “Pedro” who possesses the types of expertise indicated by the search input, the communicator application updates the requesting user's communicator interface such that the requesting user's communicator interface indicates that “Pedro” possesses the types of expertise indicated by the search input.

The requesting user is less likely to try to communicate with an expert when the requesting user does not know the expert. Furthermore, the expert is less likely to accept a communication request from the requesting user when the expert does not know the requesting user. However, if the requesting user knows that he or she can get another user to introduce him or her to the expert, the requesting user may be more likely to try to communicate with the expert. Furthermore, if the expert knows a third user and the third user introduces the requesting user to the expert, the expert may be more willing to communicate with the requesting user.

To facilitate such introductions, the communicator application attempts to identify one or more user chains that link the requesting user to users who possess the types of expertise indicated by the search input. In some implementations, a user chain that links a first user to a second user is an ordered set of users that includes the first user, the second user, and zero or more intervening users, the set of users having the property that for each user in the set of users other than the first user, the user is on the buddy list of the previous user in the set of users. The set of users in the user chain in addition to the first user and the second user is an intervening user set. In other implementations, a user chain that links a first user to a second user is an ordered set of user that includes the first user, the second user, and zero or more intervening users, the set of users having the property that for each user in the set of users other than the second user, the user is on the buddy list of the next user in the set of users.

In some implementations, the communicator application only attempts to identify experts within the requesting user's personal network. The user's personal network includes a set of users where, for each user in the set of users, there exists a user chain that links the requesting user to the user where the user chain includes at most a particular number of users. For instance, the user's personal network could include each of the users 104 for which a user chain containing no more than four users exists.

If the communicator application is able to identify one or more user chains linking the requesting user to users possessing the types of expertise indicated by the search input, the communicator application displays the user chains on the requesting user's communicator interface. For example, if the communicator application determines that the buddy list of the requesting user does not contain a user possessing the types of expertise indicated by the search input, the communicator application may determine that “Kumar” possesses the types of expertise indicated by the search input and that the buddy list of “Kumar” contains a user “Sergey” who is on the buddy list of the requesting user. In this example, the communicator application updates the requesting user's communicator interface such that the requesting user's communicator interface indicates that “Kumar” possesses the types of expertise indicated by the search input and that the requesting user is linked to “Kumar” by way of “Sergey.”

In some implementations, when the communicator application displays user identifiers that identify experts, the communicator application also displays availability indicators for the experts in the requesting user's communicator interface. The availability indicators indicate whether the experts are available to begin communication sessions. In this way, the requesting user is able to determine which ones of the experts are currently available to begin a communication session. The requesting user may only want to try to initiate communication sessions with experts who are currently available to begin communication sessions. For example, “Kyle” and “Amit” may be experts and “Kyle” is currently available to begin a communication session, but “Amit” is not currently available to begin a communication session. In this example, the requesting user may choose to initiate a communication session with “Kyle” instead of trying to initiate a communication session with “Amit.”

When a user chain includes three or more users, the communicator application displays an availability indicator for the expert and availability indicators for each intervening user in the user chain. In this way, the requesting user is able to determine whether each user in the user chain is currently available to begin a communication session. Because the requesting user is able to determine whether each user in the user chain is currently available to begin a communication session, the requesting user may choose to seek an introduction to an expert through an intervening user who is currently available to begin a communication session. For example, the communicator application may display in the requesting user's communicator interface a first user chain in which the requesting user is linked to an expert by way of “Erica” and a second user chain in which the requesting user is linked to the expert by way of “Janet.” In this example, “Erica” may not be currently available to begin a communication session, but “Janet” is currently available to begin a communication session. Furthermore, in this example, the requesting user may choose to initiate a communication session with “Janet” in order to be introduced to the expert instead of trying to initiate a communication session with “Erica” in order to be introduced to the expert.

In different instances, the requesting user may request a first user to introduce the requesting user to a second user in different ways. In one example, the requesting user may send an introduction request to the first user. In this example, the introduction request indicates that the requesting user wants the first user to introduce the requesting user to the second user. In this example, the introduction request may take a variety of forms. For instance, the introduction request may take the form of an instant messenger message. In another instance, the introduction request may take the form of an invitation to start a voice or video conversation.

In another example, the requesting user may request a first user to introduce the requesting user to a second user by inviting the first user and the second user to join a group communication session. In this other example, the requesting user, the first user, and the second user can converse with one another within the same communication session. For instance, if the group communication session is a voice conversation, the requesting user, the first user, and the second user are able to hear each others' voices.

In some implementations, the requesting user is able to use the requesting user's communicator interface to provide feedback input to the communicator application. The feedback input indicates how helpful one or more users were to the requesting user. For example, if an expert did a good job in answering the requesting user's questions, the requesting user may use the requesting user's communicator interface to provide positive feedback input regarding the expert. On the other hand, if the expert did a poor job in answering the requesting user's questions or was unresponsive to the requesting user's questions, the requesting user may use the requesting user's communicator interface to provide negative feedback regarding the expert. Furthermore, the requesting user may provide feedback input regarding how helpful a user was in introducing the requesting user to another user.

In different implementations, the communicator application employs the feedback input in different ways. For instance, in one example implementation, when the communicator application identifies one or more user chains in response to a search input, the communicator application causes the requesting user's communicator interface to display rating indicators for at least some of the users in the user chains. The rating indicators indicate ratings for users in the user chains. The ratings for the users are based on feedback input regarding the users provided to the communicator application by other ones of the users 104. Such ratings indicators may help the requesting user choose one of the experts with which to communicate. For instance, the requesting user may choose to try to communicate with an expert having a high rating instead of an expert having a low rating. In another example implementation, the users 104 are employees of an enterprise. In this other example implementation, management of the enterprise may reward ones of the users 104 who have high ratings. In this way, management of the enterprise can encourage the users 104 to be responsive to requests for advice. Furthermore, ratings of intervening users may help the requesting user to decide the users through which the requesting user will seek introductions.

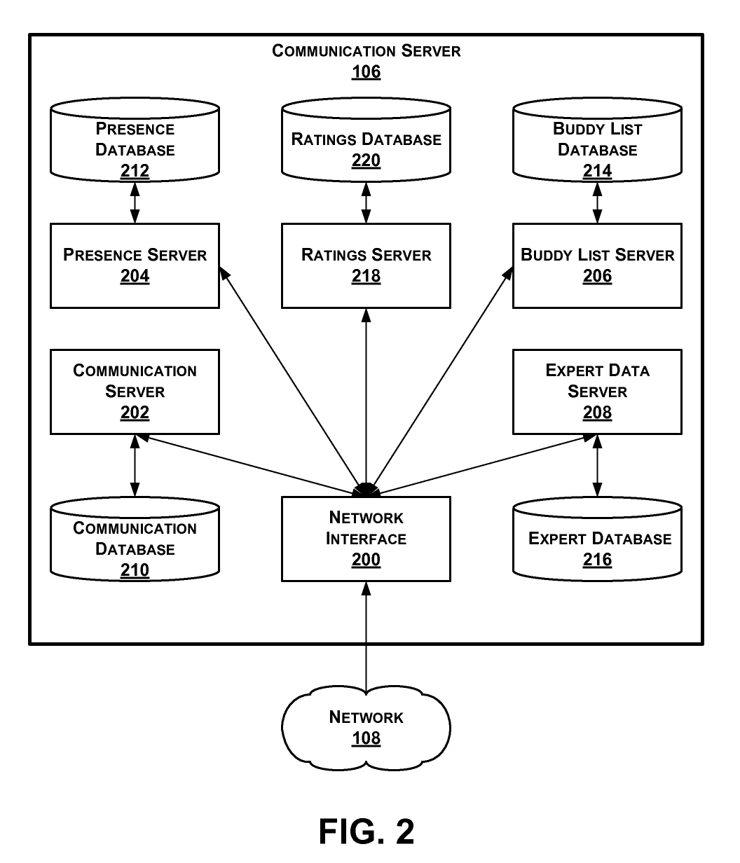

FIG. 2 is a block diagram illustrating logical components in an example implementation of the communication server 106. It should be appreciated that FIG. 2 is an example provided for purposes of explanation only. In other instances, the communication server 106 may contain different logical components. As used in this patent document, logical components include sub-parts of a system, the sub-parts having a well-defined purposes and functionalities.

As illustrated in the example of FIG. 2, the communication server 106 comprises a network interface 200. The network interface 200 enables the communication server 106 to communicate with other devices connected to the network 108. In different implementations, the network interface 200 is implemented in different ways. For instance, in one example implementation, the network interface 200 is implemented as a single network interface card. In another example implementation, the network interface 200 is implemented as a plurality of network interface cards. Furthermore, in some implementations, the communication server 106 comprises multiple logical network interfaces.

Furthermore, in the example of FIG. 2, the communication server 106 comprises a communication server 202, a presence server 204, a buddy list server 206, an expert data server 208, and a ratings server 218. In some example implementations, a single computing device hosts the communication server 202, the presence server 204, the buddy list server 206, the expert data server 208, and the ratings server 218. In other example implementations, two or more computing devices host one or more of the communication server 202, the presence server 204, the buddy list server 206, the expert data server 208, and the ratings server 218. For instance, a first computing device may host the communication server 202, the presence server 204, and the buddy list server 206 and another computing device may host the expert data server 208 and the ratings server 218. Furthermore, in other implementations, the functions of two or more of the communication server 202, the presence server 204, the buddy list server 206, the expert data server 208, or the ratings server 218 are performed by a single server. For instance, the functionality of the expert data server 208 and the functionality of the ratings server 218 may be performed by a single server.

In the example of FIG. 2, the communication server 106 stores a communication database 210, a presence database 212, a buddy list database 214, an expert database 216, and a ratings database 220. In different implementations, the communication server 202 stores the communication database 210, the presence database 212, the buddy list database 214, the expert database 216, and the ratings database 220 in different ways. In one example implementation, the communication server 106 stores the communication database 210, the presence database 212, the buddy list database 214, the expert database 216, and the ratings database 220 as one or more relational databases. For instance, in this example implementation, a relational database includes the communication database 210, the presence database 212, the buddy list database 214, and the ratings database 220 and another relational database includes the expert database 216. In another example implementation, the communication database 210, the presence database 212, the buddy list database 214, the expert database 216, and the ratings database 220 are stored at separate databases.

The communication server 202 sets up communication sessions between the users 104. In the example of FIG. 2, the communication server 202 uses data in the communication database 210 to set up communication sessions between the users 104. For example, the communication database 210 may contain telephone numbers of users. In this example, the communication server 202 uses a telephone number in the communication database 210 to make a telephone call to a user. In another example, the communication database 210 comprises video conference preferences for each of the users 104. In this other example, the communication server 202 uses the video conference preferences to set up video conferences between the users 104.

The presence server 204 provides access to presence data. In the example of FIG. 2, the presence server 204 uses the presence database 212 to provide access to the presence data. For example, the presence server 204 receives presence data from the client devices 102. The presence data reflects the availability of the users 104 to accept new communication sessions. For instance, the presence server 204 may receive presence data indicating that some users are available, some users are away from their computers, some users do not want to be disturbed, or that some users are not logged in to the communicator application. The presence server 204 stores such presence data in the presence database 212. Furthermore, the presence server 204 provides responses to requests for presence data.

The buddy list database 214 stores data representing the buddy lists of each of the users 104. For example, the buddy list database 214 may contain a separate database entry for each of the users 104. In this example, the entry for a user contains user identifiers of each user in the user's buddy list. The buddy list server 206 responds to requests for buddy lists. Furthermore, in some implementations, the buddy list server 206 updates the buddy lists of the users 104 in response to requests from the users 104 or others.

The expert database 216 stores data indicating the types of expertise possessed by the users 104. For example, the expert database 216 may contain an entry indicating that the user 104A possesses expertise in C++ and the expert database 216 may contain another entry indicating that the user 104B possesses expertise in Java. The expert data server 208 responds to requests for data representing users having particular types of expertise.

The ratings database 220 stores data relevant to ratings of the users 104. In different implementations, the ratings database 220 may store a wide variety of different types of data relevant to ratings of the users 104. For instance, in one example implementation, the ratings database 220 stores numerical scores indicative of the ratings of the users 104. In another example implementation, the ratings database 220 stores comments about how the users 104 responded to requests for expert advice. The ratings server 218 receives and processes service requests to store ratings data into the ratings database 220. In addition, the ratings server 218 receives and processes service requests to retrieve ratings data from the ratings database 220. Furthermore, in some implementations, the ratings server 218 may respond to service requests by generating ratings data from various disparate pieces of data in the ratings database 220. For example, the ratings database 220 may store scores given to a user by a plurality of other users. In this example, the ratings server 218 may respond to a service request for ratings data regarding the user by calculating an average score given to the user based on the scores given to the user by the other users.

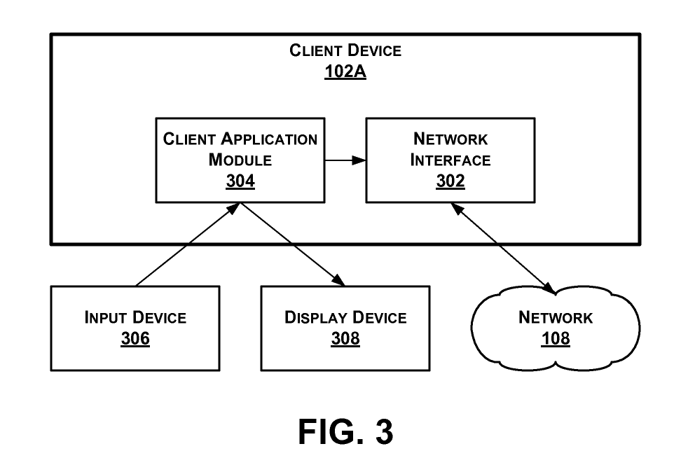

FIG. 3 is a block diagram illustrating logical components in an example implementation of the client device 102A. It should be appreciated that FIG. 3 is an example provided for purposes of explanation only. In other instances, the client device 102A may contain different logical components. Furthermore, it should be understood that other ones of the client devices 102 may include logical components similar to or different than those illustrated in the example of FIG. 3.

As illustrated in the example of FIG. 3, the client device 102A comprises a network interface 302. The network interface 302 enables the client device 102A to communicate with other devices connected to the network 108. In different instances, the network interface 302 may be implemented in different ways. For example, in one example implementation, the network interface 302 may be implemented as a network interface card.

Furthermore, as illustrated in the example of FIG. 3, the client device 102A comprises a client application module 304. In different implementations, the client application module 304 is implemented in different ways. For instance, in one example implementation, the client application module 304 is implemented as a set of software instructions executed by a processing unit of the client device 102A. In another example implementation, the client application module 304 is implemented as one or more application specific integrated circuits (ASICs).

The client application module 304 receives input from an input device 306 and provides output on a display device 308. The input device 306 may be a wide variety of different types of devices. For instance, the input device 306 may be a mouse, a touch-screen display, a keypad, a keyboard, a trackball, or another type of input device. The display device 308 may be a wide variety of different types of devices. For instance, the display device 308 may be a liquid crystal display (LCD) screen, a light-emitting diode (LED) screen, a plasma screen, a cathode ray tube display, or another type of display device.

As described in detail elsewhere in this patent document, the client application module 304 causes the display device 308 to display a user interface of the communicator application. In addition, the client application module 304 receives search input from the user 104A via the communicator interface. The search input indicates at least one type of expertise. Subsequently, the client application module 304 causes the display device 308 to display a user identifier within the communicator interface. The user identifier identifies a user possessing the type of expertise indicated by the search input.

The client application module 304 communicates with the communication server 202, the presence server 204, the buddy list server 206, the expert data server 208, and the rating server 218 at the communication server 106. In different implementations, the client application module 304 communicates with the servers at the communication server 106 in different ways. For instance, in one example implementation, the client application module 304 uses the network interface 302 to send HTTP requests to and receive HTTP responses from the servers at the communication server 106. In another example implementation, the client application module 304 uses the network interface 302 to send remote procedural call protocol messages to the servers at the communication server 106.

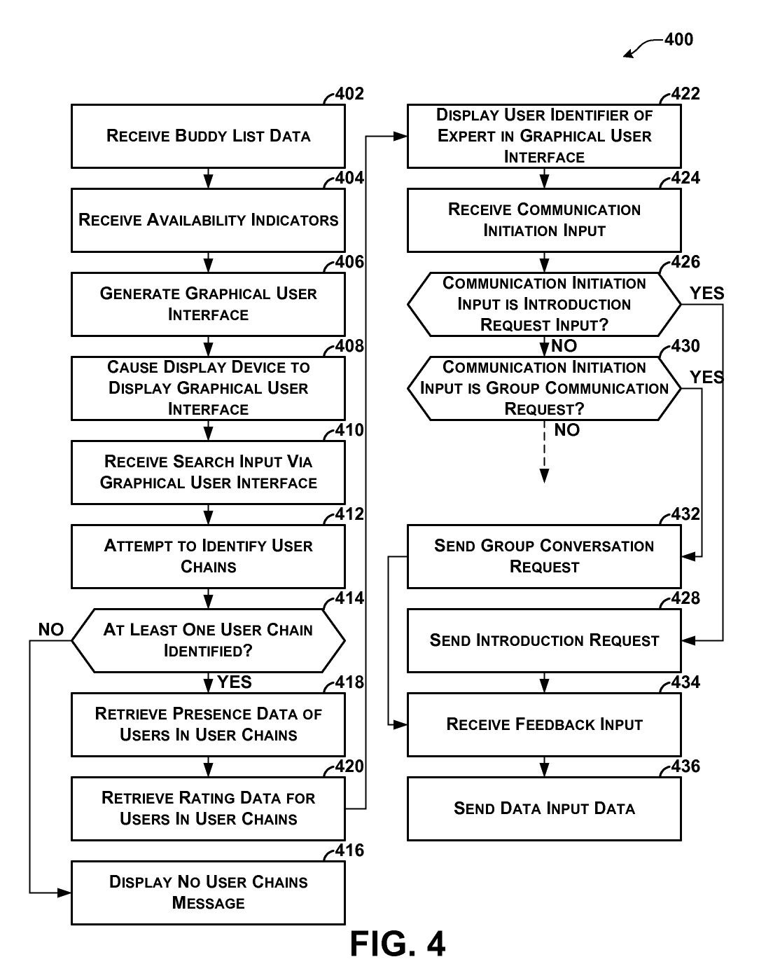

FIG. 4 is a flowchart illustrating an example operation 400 to use the communicator application to establish a communication session with an expert. It should be appreciated that the operation 400 is an example provided for purposes of explanation only. In other implementations, operations to use the communicator application to establish communication with an expert may involve more or fewer steps, or may involve the steps of the operation 400 in a different order. Furthermore, the operation 400 is explained with reference to other figures of this patent document. It should be appreciated that other operations to use the communicator application to establish communication with an expert may be used in different systems and in computing systems having logical components other than those illustrated in the figures of this patent document.

As illustrated in the example of FIG. 4, the operation 400 starts when the client application module 304 receives buddy list data (402). The buddy list data represents the buddy list of the user 104A. As discussed above, the buddy list of the user 104A comprises a set of users. In some example implementations, the client application module 304 receives the buddy list data in response to a service request sent by the client application module 304 to the buddy list server 206 via the network 108. In this example implementation, the client application module 304 receives a service response from the buddy list server 206 via the network 108. The service response from the buddy list server 206 includes the buddy list data.

In addition, the client application module 304 receives presence data (404). The presence data indicates whether users on the buddy list of the user 104A are available to begin communication sessions. In some example implementations, the client application module 304 receives the presence data in response to a service request sent by the client application module 304 to the presence server 204. In this example implementation, the client application module 304 receives a service response from the presence server 204. The service response from the presence server 204 includes the presence data.

After client application module 304 after receives the buddy list data and the presence data, the client application module 304 uses the buddy list data and the presence data to generate a communicator interface of the user 104A (406). The client application module 304 generates the communicator interface of the user 104A such that the communicator interface contains one or more user identifiers that identify users on the buddy list of the user 104A and such that the communicator interface of the user 104A contains availability indicators that indicate whether users on the buddy list of the user 104A are available to begin communication sessions.

After generating the communicator interface of the user 104A, the client application module 304 causes the display device 308 to display the communicator interface of the user 104A (408). In different implementations, the client application module 304 causes the display device 308 to display the communicator interface of the user 104A in different ways. For instance, in one example implementation, the client application module 304 causes the display device 308 to display the communicator interface of the user 104A by sending instructions to a video interface card in the client device 102A. In this example implementation, the instructions instruct the video interface card to send signals representative of the communicator interface of the user 104A to the display device 308. In another example implementation, the client application module 304 causes the display device 308 to display the communicator interface of the user 104A by storing the communicator interface of the user 104A in a memory location. In this example, a video interface card automatically sends signals representative of images stored at the memory location to the display device 308.

When the display device 308 displays the communicator interface of the user 104A, the client application module 304 receives search input from the user 104A via the communicator interface of the user 104A (410). The user 104A uses the input device 306 to provide the search input to the client application module 304. The search input indicates one or more types of expertise. For example, the search input may indicate “C++” and “Java.” In this example, “C++” and “Java” are two types of expertise.

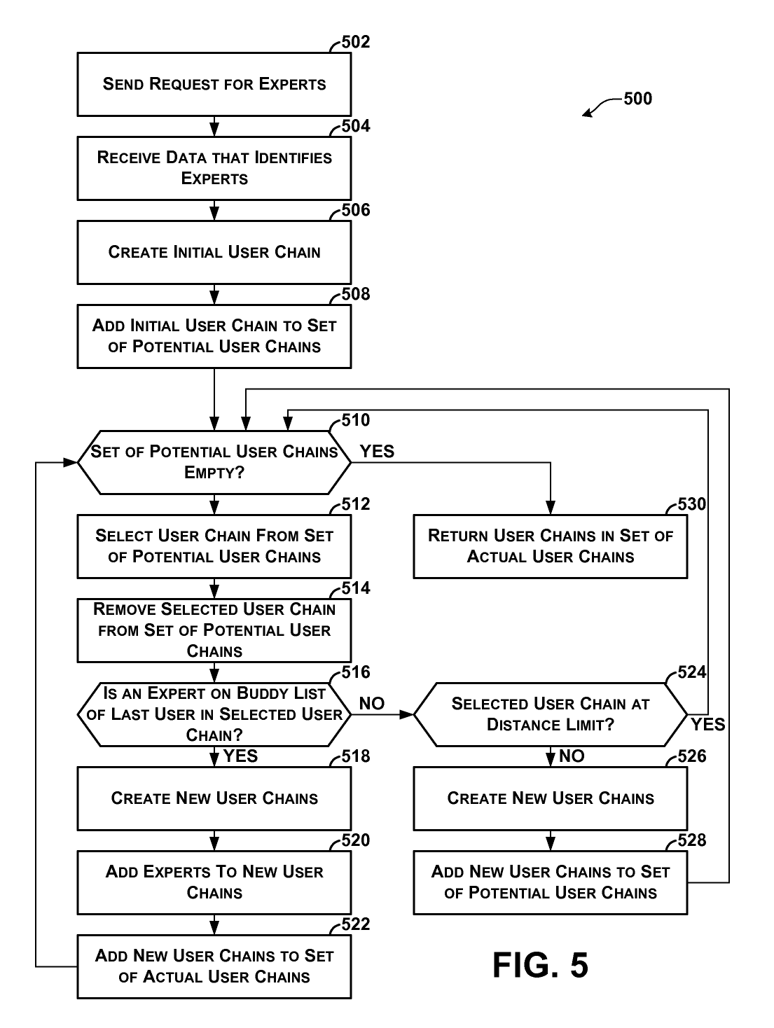

After receiving the search input, the client application module 304 performs a set of actions that attempts to identify one or more user chains that link the user 104A to users possessing the types of expertise indicated by the search input (412). In different implementations, the client application module 304 performs different sets of actions to identify the user chains. This patent document describes one example set of actions to identify the user chains with reference to FIG. 5.

Once the client application module 304 has attempted to identify the user chains, the client application module 304 determines whether at least one user chain has been identified (414). If no user chain has been identified (“NO” of 414), the client application module 304 displays a message in the communicator interface of the user 104A indicating that the communicator application was not able to identify any user chains (416).

On the other hand, if at least one user chain has been identified (“YES” of 414), the client application module 304 retrieves presence data from the presence server 204 for users in the user chains (418). The presence data indicates the availability of each of the users in the user chains to begin communication sessions. In addition, the client application module 304 retrieves ratings data from the ratings server 218 (420). The ratings data indicates ratings of the experts in the user chains. In some implementations, the ratings data also indicates ratings of intervening users in the user chains. For instance, in such implementations, if a user chain includes the user 104A, Aaron, Betty, and Clark, the ratings data may indicate ratings for Aaron, Betty, and Clark.

After receiving the presence data and the ratings data, the client application module 304 causes the communicator interface of the user 104A to include user identifiers that identify at least some of the users in at least one of the identified user chains (422). For example, the user 104A, Aaron, Betty, and Clark form a user chain that links the user 104A to Clark, a user possessing the types of expertise indicated by the search input. In this example, the client application module 304 may cause the communicator interface of the user 104A to contain a user identifier identifying Aaron, a user identifier identifying Betty, and a user identifier identifying Clark. Furthermore, the client application module 304 uses the presence data causes the communicator interface of the user 104A to include availability indicators that indicate the availability of the users in the user chain to begin communication sessions. In addition, the client application module 304 causes the communicator interface of the user 104A to include ratings indicators that indicate ratings of at least some of the users in the user chain. In this example, the client application module 304 may cause the communicator interface of the user 104A to include a ratings indicator for Clark.

Furthermore, in implementations where the ratings data indicates ratings of intervening users in the user chains, the client module 304 causes the communicator interface of the user 104A to include ratings indicators that indicate ratings of the intervening users. The ratings of the intervening users may help the user 104A decide how to contact an expert. For example, suppose the identified user chains include a first user chain that includes the user 104A, Aaron, and Clark and another user chain includes the user 104A, Derrick, and Clark. In this example, the ratings indicators for Aaron and Derrick may help the user 104A to decide whether to contact Aaron or Derrick for an introduction to Clark.

Subsequently, the client application module 304 receives communication initiation input from the user 104A via the communicator interface of the user 104A (424). The communication initiation input indicates one or more target users. The user 104A may use the input device 306 to provide the communication initiation input to the client application module 304. In different implementations, the client application module 304 receives the communication initiation input from the user 104A in different ways. For instance, in one example implementation, the input device 306 is a pointing device, such as a mouse. In this example implementation, the user 104A provides the communication initiation input to the client application module 304 by right-clicking on a user identifier of a user in a chain linking the user 104A to an expert. In this example implementation, the user identified by the user identifier is the target user. Moreover, in this example implementation, the client application module 304 responds by causing the communicator interface of the user 104A to contain a pop-up menu containing controls that, when selected by the user 104A, provide different types of communication initiation input to the client application module 304. In another example implementation, the user 104A provides the communication initiation input to the client application module 304 by double-clicking on a user identifier displayed in the communicator interface of the user 104A. In this example implementation, the type of communication initiation input may be a default type of communication initiation input. In other instances, the client application module 304 causes the communicator interface of the user 104A to prompt the user 104B to select a type of communication session.

After receiving the communication initiation input, the client application module 304 determines whether the communication initiation input includes an introduction request input (426). The introduction request input indicates that the user 104A wants the communicator application to send an introduction request to a user in one of the users chains to introduce the user 104A to another user in the user chain. In one example, a user chain includes Aaron, Daisy, and John. In this example, John is an expert and Daisy is an intervening user. Furthermore, in this example, Aaron is on the buddy list the user 104A, but neither Daisy nor John are on the buddy list of the user 104A. Consequently, in this example, the user 104A may want Aaron to introduce the user 104A to Daisy and subsequently may want Daisy to introduce the user 104A to John.

If the client application module 304 determines that the communication initiation input includes an introduction request input (“YES” of 426), the client application module 304 sends an introduction service request to the communication server 202 (428). In response to the introduction service request, the communication server 202 sends an introduction request to the target user of the communication initiation input. The introduction request contains data representing a message indicating that the user 104A wants the target user to introduce the user 104A to another user. In different implementations, the introduction request includes different content. For example, in one example implementation, the introduction request states “I need the advice of an expert. To help me consult with the expert, I would like you to introduce me to ______.” In this example, the name of a user is inserted in the blank.

On the other hand, if the client application module 304 determines that the communication initiation input does not include an introduction request input (“NO” of 426), the client application module 304 determines whether the communication initiation input includes a group communication request input (430). A group communication request input includes a request to initiate a group communication session. A group communication session includes a communication session involving more than two users. If the client application module 304 determines that the communication initiation input includes a group communication request input (“YES” of 430), the client application module 304 sends a group communication request to the communication server 202 (432). In response to the group communication request, the communication server 202 sends a group communication request to the target users.

If the client application module 304 determines that the communication initiation input does not include a group communication request input (“NO” of 430), the client application module 304 may perform some other action. For instance, the client application module 304 may output an error.

After the client application module 304 sends the group communication request or the introduction request, the user 104A may engage in one or more communication sessions. Subsequently, the client application module 304 receives feedback input from the user 104A via the communicator interface of the user 104A (434). The feedback input indicates how helpful one or more users in the user chain were to the user 104A. After the client application module 304 receives the feedback input, the client application module 304 sends data representing the feedback data to the ratings server 218 (436).

FIG. 5 is a flowchart illustrating an example operation 500 to identify user chains that link the user 104A to experts. It should be appreciated that the operation 500 is an example provided for purposes of explanation only. In other implementations, operations to identify user chains may involve more or fewer steps, or may involve the steps of the operation 500 in a different order. Furthermore, the operation 500 is explained with reference to other figures of this patent document. It should be appreciated that other operations to identify user chains may be used in different systems and in computing systems having logical components other than those illustrated in the figures of this patent document.

As illustrated in the example of FIG. 5, the operation 500 begins when the client application module 304 sends a request to the expert data server 208 via the network 108 (502). The request requests data that identify users possessing the types of expertise indicated by a search input (i.e., the experts). Subsequently, the client application module 304 receives data that identifies the experts (504).

Next, the client application module 304 creates an initial user chain (506). The initial user chain only contains the requesting user (e.g., the user 104A). After creating the initial user chain, the client application module 304 adds the initial user chain to a set of potential user chains (508).

The client application module 304 then determines whether the set of potential user chains is empty (510). The set of potential user chains is empty when there are no user chains in the set of potential user chains. If the set of potential user chains is not empty (“NO” of 510), the client application module 304 selects a user chain from the set of potential user chains (512). In different implementations, the client application module 304 may select the user chain from the set of potential user chains in a variety of ways. For instance, in one example implementation, the client application module 304 selects the user chain from the set of potential user chains at random. In another example implementation, the set of potential user chains is a stack and the client application 304 selects the top user chain in the set of potential user chains. After selecting the user chain from the set of potential user chains, the client application module 304 removes the selected user chain from the set of potential user chains (514).

Next, the client application module 304 determines whether one of the experts is on the buddy list of the last user on the selected user chain (516). To determine whether one of the experts is on the buddy list of the last user on the selected user chain, the client application module 304, in one example implementation, sends a request to the buddy list server 206 for the buddy list of the last user on the selected user chain.

If an expert is on the buddy list of the last user on the selected user chain (“YES” of 516), the client application module 304 creates a copy of the selected user chain for each expert on the buddy list of the last user on the selected user chain (518). The client application module 304 then adds experts on the buddy list of the last user in the selected buddy list to the ends of the new user chains (520). For example, if the selected user chain includes user A and user B and users C and D are experts, the client application module 304 creates a first new user chain and adds the user C to the end of the first new user chain. In this example, the client application module 304 also creates a second new user chain and adds the user D to the end of the second new user chain. In this example, the first new user chain includes user A, user B, and user C and the second new user chain includes user A, user B, and user D.

The client application module 304 then adds the new user chains to a set of actual user chains (522). After adding the selected user chain to the set of actual user chains, the client application module 304 again determines whether the set of potential user chains is empty (510) and so on.

If the client application module 304 determines that none of the experts are on the buddy list of the last user on the selected user chain (“NO” of 516), the client application module 304 determines whether the selected user chain is at a distance limit (524). The distance limit is a measure of how long a user chain that links the user 104A and an expert can be before a search for experts is aborted. In different implementations, the distance limit has different values. For instance, in one example implementation, the distance limit is five. In other words, in this example, there client application module 304 will abort a search for experts when there are more than five users in a user chain that links the user 104A and any of the experts.

If the client application determines that the selected user chain is at the distance limit (“YES” of 524), the client application module 304 again determines whether the set of potential user chains is empty (510) and so on. If the client application module 304 determines that the selected user chain is not at the distance limit (“NO” of 524), the client application module 304 creates a new user chain for each user on the buddy list of the last user in selected user chain (526). The new user chains are copies of the selected user chain, except users on the buddy list of the last user in the selected user chain are added as the new last users in the new user chains (526). The client application module then adds the new user chains to the set of potential user chains (528). After adding the new user chains to the set of potential user chains, the client application module 304 again determines whether the set of potential user chains is empty (510) and so on.

If the client application module 304 determines that the set of potential user chains is empty (“YES” of 510), the client application module 304 returns the user chains in the set of actual user chains (530). In this way, the client application module 304 identifies the user chains that link the user 104A to users that possess the expertise indicated by the search input.

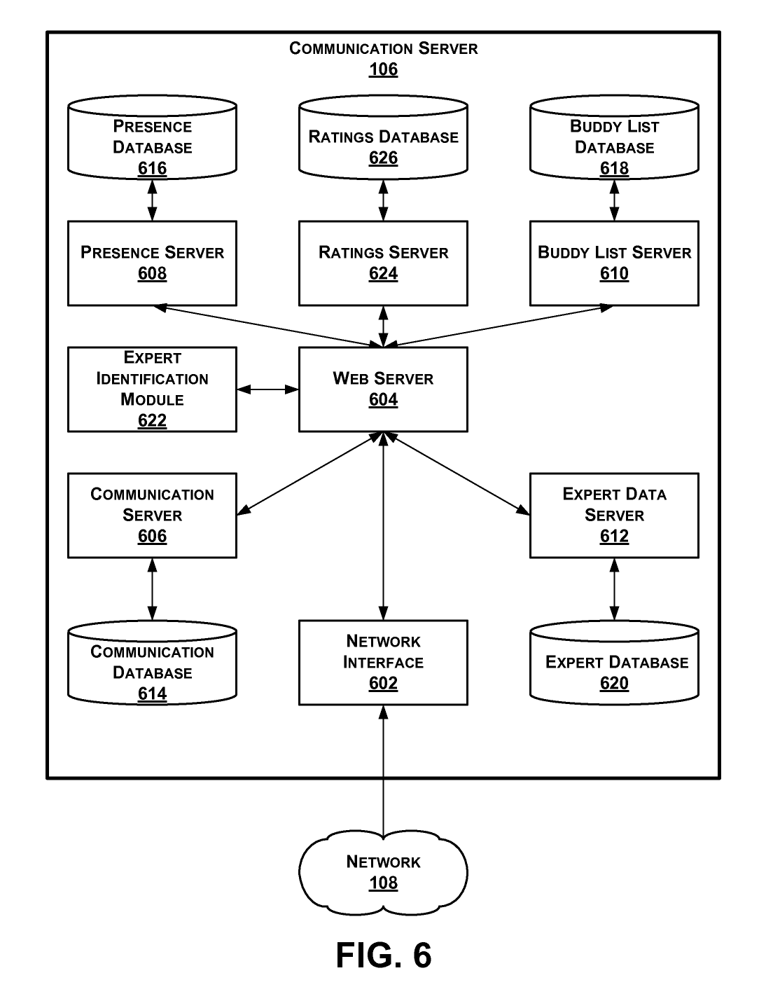

FIG. 6 is a block diagram illustrating logical components in another example implementation of the communication server 106. It should be appreciated that FIG. 6 is an example provided for purposes of explanation only. In other instances, the communication server 106 may contain different logical components.

In the example of FIG. 6, the communication server 106 comprises a network interface 602, a web server 604, a communication server 606, a presence server 608, a buddy list server 610, an expert data server 612, an expert identification module 622, and a ratings server 624. Furthermore, as illustrated in the example of FIG. 6, the communication server 106 stores a communication database 614, a presence database 616, a buddy list database 618, an expert database 620, and a ratings database 626. Although the communication database 614, the presence database 616, the buddy list database 618, the expert database 620, and the ratings database 626 are illustrated as being separate databases in the example of FIG. 6, it should be appreciated that in other implementations, one or more of the communication database 614, the presence database 616, the buddy list database 618, the expert database 620, and the ratings database 626 may be implemented as a single database.

The communication server 606, the presence server 608, the buddy list server 610, the expert data server 612, and the ratings server 624 may be similar in functionality and implementation as the communication server 202, the presence server 204, the buddy list server 206, the expert data server 208 and the ratings server 218 illustrated in the example of FIG. 2. Moreover, the communication database 614, the presence database 616, the buddy list database 618, the expert database 620, and the ratings database 626 may contain data similar to the communication database 210, the presence database 212, the buddy list database 214, the expert database 216, and the ratings database 220 illustrated in the example of FIG. 2.

However, in the example of FIG. 6, the web server 604 receives and processes web service requests from the network 108. As part of processing the web service requests, the web server 604 sends service requests to the communication server 606, the presence server 608, the buddy list server 610, the expert data server 612, and the ratings server 624. Furthermore, the web server 604 receives service responses from the communication server 606, the presence server 608, the buddy list server 610, and the expert data server 612. The web server 604 then sends web service responses based on the service responses.

In different implementations, the web server 604 is implemented in different ways. For instance, in one example implementation, the web server 604 is implemented as a set of software instructions that, when executed by a processing unit of the communication server 106 cause the communication server 106 to provide a web server. In another example implementation, the web server 604 is implemented as one or more ASICs.

Furthermore, as illustrated in the example of FIG. 6, the communication server 106 comprises an expert identification module 622. The expert identification module 622 attempts to identify user chains that link users to experts. In one example implementation, the expert identification module 622 attempts to identify user chains that link users to experts by performing an operation similar to the operation 500 illustrated in the example of FIG. 5.

In different instances, the expert identification module 622 is implemented in different ways. For instance, in one example implementation, the expert identification module 622 is implemented as a set of software instructions executed by a processing unit in the communication server 106. In another example implementation, the expert identification module 622 comprises one or more ASICs.

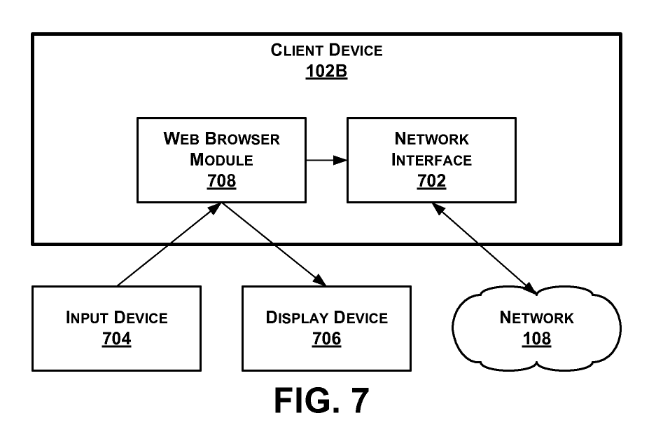

FIG. 7 is a block diagram illustrating logical components in an example implementation of the client device 102B. It should be appreciated that FIG. 7 is an example provided for purposes of explanation only. In other instances, the client device 102B may contain different logical components. Furthermore, it should be understood that other ones of the client devices 102 may include logical components similar to or different than those illustrated in the example of FIG. 7. The example of FIG. 7 is explained with reference to other figures of this patent document. It should be appreciated that the client device 102B as illustrated in the example of FIG. 7 may be used with systems other than the system 100 and with communication servers other than the communication server illustrated in the figures of this patent document.

In the example of FIG. 7, the client device 102B is similar to the client device 102A illustrated in the example of FIG. 3. For instance, the client device 102B includes a network interface 702, an input device 704, and a display device 706. The network interface 702 may have similar functionality as the network interface 302 illustrated in the example of FIG. 3. Likewise, the input device 704 and the display device 706 may be similar functionality as the input device 306 and the display device 308 illustrated in the example of FIG. 3.

However, instead of including the client application module 304, the client device 102B includes a web browser module 708. The web browser module 708 causes the client device 102B to provide a web browser application to the user of the client device 102B. To provide the communicator application to the user 104B, the web browser module 708 causes the client device 102B to send requests to and receive responses from the web server 604 at the communication server 106.

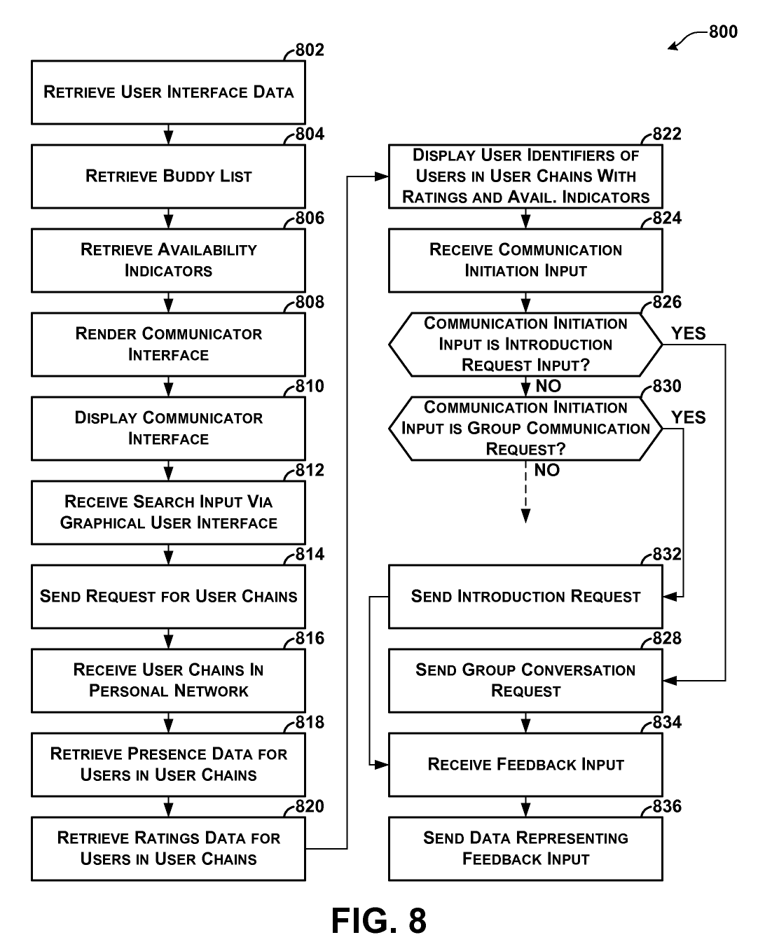

FIG. 8 is a flowchart illustrating another example operation 800 to use the communicator application to establish a communication session with an expert. It should be appreciated that the operation 800 is an example provided for purposes of explanation only. In other implementations, operations to use a communicator application to establish a communication session with an expert may involve more or fewer steps, or may involve the steps of the operation 800 in a different order. Furthermore, the operation 800 is explained with reference to other figures of this patent document. It should be appreciated that other operations to establish a communication session with an expert may be used in different systems and in computing systems having logical components other than those illustrated in the figures of this patent document.

As illustrated in the example of FIG. 8, the operation 800 begins when the web browser module 708 retrieves user interface data from the web server 604 (802). Retrieving the user interface data from the web server 604 entails sending a request to the web server 604 and receiving a response from the web server 604. In different implementations, the web browser module 708 sends the request for the user interface data in different ways. For instance, in one example implementation, the web browser module 708 uses the Hypertext Transfer Protocol (HTTP) to send the request for the user interface data. The user interface data represents a communicator interface of the user 104B. In different implementations, the user interface data is formatted in different ways. For instance, in one example implementation, the user interface data conforms to the Hypertext Markup Language (HTML). In another example implementation, the user interface data conforms to the Extensible Markup Language.

In addition, the web browser module 708 retrieves data representing a buddy list of the user 104B (804). In some implementations, the web browser module 708 receives the data representing the buddy list of the user 104B as part of the user interface data. In other implementations, the web browser module 708 sends a separate request to the web server 604 for the data representing the buddy list. In such implementations, the web server 604 may send a service request to the buddy list server 610 for the buddy list of the user 104B. In different implementations, the data representing the buddy list of the user 104B is formatted in different ways. For instance, the data representing the buddy list of the user 104B may conform to XML, HTML, or another data format.

Furthermore, the web browser module 708 retrieves presence data of users on the buddy list of the user 104B (806). In some implementations, the web browser module 708 receives the presence data as part of the user interface data. In other implementations, the web browser module 708 sends a separate request to the web server 604 for the data representing the availability indicators. In such implementations, the web server 604 may process the request at least in part by sending a service request to the presence server 608, receiving data representing the availability indicators from the presence server 608, and sending the same or different data representing the availability indicators to the web browser module 708. Furthermore, in some implementations, the user interface data comprises a script that configures the web browser module 708 to send requests for presence data on a recurring basis. Consequently, the web browser module 708 has access to relatively current presence data. In different implementations, the presence data is formatted in different ways. For instance, the presence data may conform to XML, HTML, or another data format.

The web browser module 708 uses the user interface data, the buddy list data, and the presence data to render the communicator interface of the user 104B (808). The web browser module 708 then causes the display device 706 to display the communicator interface of the user 104B (810).

Subsequently, the web browser module 708 receives search input via the communicator interface of the user 104B (812). In response to receiving the search input, the web browser module 708 sends a request to the web server 604 for user chains that link the user 104B to users possessing the types of expertise indicated by the search input (i.e., the experts) (814). When the web server 604 receives the request, the web server 604 sends a request to the expert identification module 622. In one example implementation, the expert identification module 622 uses an operation similar to the operation 500 illustrated in the example of FIG. 5 to identify user chains that link the user 104B to the experts. Furthermore, after the expert identification module 622 identifies the user chains that link the user 104B to the experts, the expert identification module 622 provides data representing the user chains to the web server 604. The web server 604 may then forward the data to the web browser module 708 or provide other data representing the user chains to the web browser module 708. As a result, the web browser module 708 receives from the web server 604 data representing the user chains (816).

After receiving the data representing the user chains, the web browser module 708 retrieves presence data for users in the user chains from the web server 604 (818). In addition, the web browser module 708 retrieves from the web server 604 ratings data for at least some of users in the user chains (820). The web browser module 708 then uses the data representing the user chains, the presence data, and the ratings data to display in the communicator interface of the user 104B user identifiers of users in the user chains along with ratings indicators and availability indicators of at least some users in the user chains (822).

Subsequently, the web browser module 708 receives communication initiation input via the communicator interface of the user 104B (824). If the communication initiation input includes introduction request input (“YES” of 826), the web browser module 708 sends a group communication request to the web server 604 (828).

On the other hand, if the communication initiation input does not include introduction request input (“NO” of 826) and if the communication initiation input does not include a group communication request (“NO” of 830), the web browser module 708 may perform some other operation. However, if the communication initiation input does not include introduction request input (“NO” of 826) and the communication initiation input includes a group communication request (“YES” of 830), the web browser module 708 sends a group communication request to the web server 604 (832).

Subsequently, the web browser module 708 receives feedback input from the user 104B (834). The web browser module 708 then sends a request to process the feedback input to the web server 608 (836).

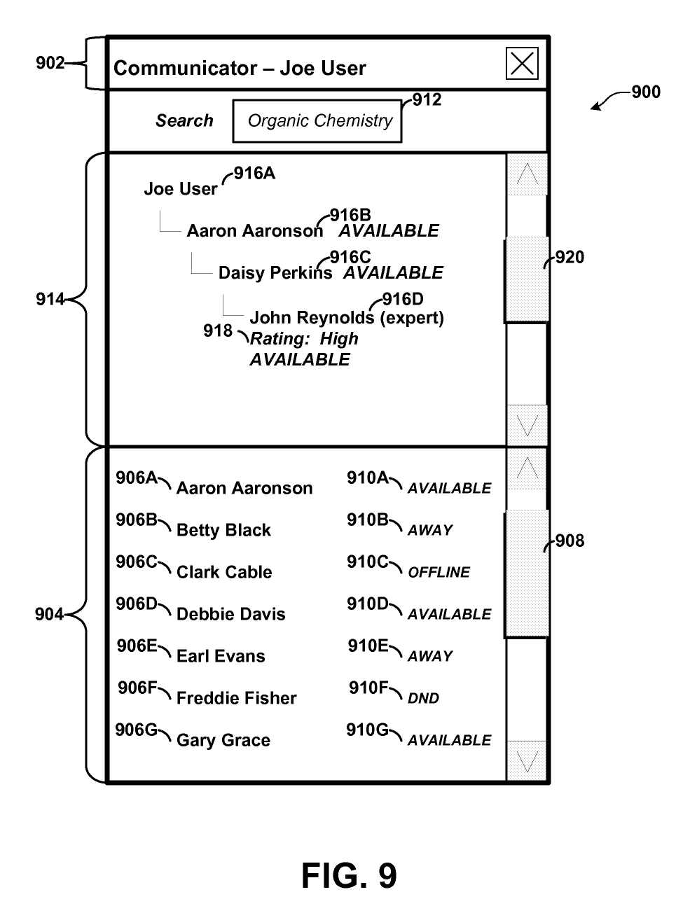

FIG. 9 is a diagram illustrating an example graphical user interface 900 of the communicator application. It should be appreciated that the example of FIG. 9 is provided for purposes of explanation only and is not intended to represent a sole type of graphical user interface that can be used with the techniques of this patent document.

The GUI 900 comprises a title bar 902. The title bar 902 identifies the GUI 900 as the user interface of the communicator application and identifies that “Joe User” is the user of the GUI 900.

In addition, the GUI 900 comprises a buddy list pane 904. The buddy list pane 904 includes user identifiers 906A-906G (collectively, “user identifiers 906”). Each of the user identifiers 906 identifies a user on the buddy list of “Joe User.” As illustrated in the example of FIG. 9, the user identifiers 906 identify seven users: “Aaron Aaronson,” “Betty Black,” “Clark Cable,” “Debbie Davis,” “Earl Evans,” “Freddie Fisher,” and “Gary Grace.” The GUI 900 also includes a scroll bar 908 that enables a user to scroll the buddy list pane 904 to reveal additional user identifiers in the buddy list pane 904.

As illustrated in the example of FIG. 9, the GUI 900 includes availability indicators 910A-910G (collectively, “availability indicators 910”). Each of the user identifiers 906 is associated with one of the availability indicators 910. For instance, the user identifier 906A (i.e., “Aaron Aaronson”) is associated with the availability indicator 910A, the user identifier 906B (i.e., “Betty Black”) is associated with availability indicator 910B, and so on. In the example of FIG. 9, there are four types of availability indicators: “Available,” “Away,” “DND,” and “Offline.” An “Available” availability indicator indicates that a user is available to begin a communication session. An “Away” availability indicator indicates that a user is away from his or her computer. A “DND” (i.e., Do Not Disturb) availability indicator indicates that a user is at his or her computer, but does not want to be disturbed. An “Offline” availability indicator indicates that a user is not logged in to the communicator application. It should be appreciated that in other implementations, other availability indicators are possible.

Furthermore, as illustrated in the example of FIG. 9, the GUI 900 includes a search box 912. A user can enter search input indicating one or more types of expertise into the search box 912. In the example of FIG. 9, the user has entered “Organic Chemistry” into the search box 912. In some implementations, the user is also able to use the search box 912 to search for users on the buddy list of the user. For instance, in such implementations, the user may enter a last name in the search box 912 to request the communication application to display ones of the users 104 having the last name.

The GUI 900 also contains a results pane 914. The results pane 914 contains a set of user identifiers 916A-916D (collectively, “user identifiers 916”) that identify users in a user chain that links “Joe User” to an expert. In the example of FIG. 9, “John Reynolds” is an expert identified when the user entered the term “Organic Chemistry” in the search box 912. “Aaron Aaronson” and “Daisy Perkins” are users on a user chain that links “Joe User” to “John Reynolds.” Note that “Aaron Aaronson” is on the buddy list of “Joe User.” In the example of FIG. 9, “Aaron Aaronson” is on the buddy list of “Daisy Perkins” and “Daisy Perkins” is on the buddy list of “John Reynolds.” Aaron Aaronson and Daisy Perkins form an intervening user set. In some implementations, the results pane 914 does not appear until search input is entered in the search box 912.

The results pane 914 also includes a rating indicator 918. The rating indicator 918 indicates a rating for “John Reynolds.” In the example of FIG. 9, the rating indicator 918 indicates that the rating for “John Reynolds” is “High.” In different implementations, ratings indicators take different forms. For instance, in one example implementation, ratings indicators take the forms of stars. In this example implementation, a greater number of stars indicates that the expert has a greater rating.

Furthermore, the GUI 900 includes a scroll bar 920. The scroll bar 920 enables the user to scroll through the results pane 914 to reveal additional users chains and/or additional users in a user chain.

FIG. 10 is a block diagram illustrating example physical components of a physical computing device 1000. In some instances, the communication server 106 comprises one or more physical computing device of the type illustrated in the example of FIG. 10. Furthermore, in some instances, one or more of the client devices 102 are physical computing devices of the type illustrated in the example of FIG. 10.

As illustrated in the example of FIG. 10, the physical computing device 1000 comprises a memory unit 1002. The memory unit 1002 includes a computer-readable data storage medium capable of storing data and/or instructions. The memory unit 1002 may be a variety of different types of computer-readable storage media including, but not limited to, dynamic random access memory (DRAM), double data rate synchronous dynamic random access memory (DDR SDRAM), reduced latency DRAM, DDR2 SDRAM, DDR3 SDRAM, Rambus RAM, or other types of computer-readable storage media.

In addition, the physical computing device 1000 comprises a processing unit 1004. As mentioned above, a processing unit includes a set of one or more physical electronic integrated circuits that are capable of executing instructions. In one example, the processing unit 1004 may execute software instructions that cause the physical computing device 1000 to provide specific functionality. In this example, the processing unit 1004 may be implemented as one or more processing cores and/or as one or more separate microprocessors. For instance, in this example, the processing unit 1004 may be implemented as one or more Intel Core 2 microprocessors. The processing unit 1004 may be capable of executing instructions in an instruction set, such as the x86 instruction set, the POWER instruction set, a RISC instruction set, the SPARC instruction set, the IA-64 instruction set, the MIPS instruction set, or another instruction set. In another example, the processing unit 1004 may be implemented as an ASIC that provides specific functionality. In yet another example, the processing unit 1004 may provide specific functionality by using an ASIC and by executing software instructions.

The physical computing device 1000 also comprises a video interface 1006. The video interface 1006 enables the physical computing device 1000 to output video information to a display device 1008. The display device 1008 may be a variety of different types of display devices. For instance, the display device 1008 may be a cathode-ray tube display, an LCD display panel, a plasma screen display panel, a touch-sensitive display panel, a LED array, or another type of display device.

In addition, the physical computing device 1000 includes a non-volatile storage device 1010. The non-volatile storage device 1010 includes a computer-readable data storage medium that is capable of storing data and/or instructions. The non-volatile storage device 1010 may be a variety of different types of non-volatile storage devices. For example, the non-volatile storage device 1010 may be one or more hard disk drives, magnetic tape drives, CD-ROM drives, DVD-ROM drives, Blu-Ray disc drives, or other types of non-volatile storage devices.

The physical computing device 1000 also includes an external component interface 1012 that enables the physical computing device 1000 to communicate with external components. As illustrated in the example of FIG. 10, the external component interface 1012 enables the physical computing device 1000 to communicate with an input device 1014 and an external storage device 1016. In one implementation of the physical computing device 1000, the external component interface 1012 includes a Universal Serial Bus (USB) interface. In other implementations of the physical computing device 1000, the physical computing device 1000 may include another type of interface that enables the physical computing device 1000 to communicate with input devices and/or output devices. For instance, the physical computing device 1000 may include a PS/2 interface. The input device 1014 may be a variety of different types of devices including, but not limited to, keyboards, mice, trackballs, stylus input devices, touch pads, touch-sensitive display screens, or other types of input devices. The external storage device 1016 may be a variety of different types of computer-readable data storage media including magnetic tape, flash memory modules, magnetic disk drives, optical disc drives, and other computer-readable data storage media.

In addition, the physical computing device 1000 includes a network interface card 1018 that enables the physical computing device 1000 to send data to and receive data from an electronic communication network. The network interface card 1018 may be a variety of different types of network interface. For example, the network interface card 1018 may be an Ethernet interface, a token-ring network interface, a fiber optic network interface, a wireless network interface (e.g., WiFi, WiMax, etc.), or another type of network interface.

The physical computing device 1000 also includes a communications medium 1020. The communications medium 1020 facilitates communication among the various components of the physical computing device 1000. The communications medium 1020 may comprise one or more different types of communications media including, but not limited to, a PCI bus, a PCI Express bus, an accelerated graphics port (AGP) bus, an Infiniband interconnect, a serial Advanced Technology Attachment (ATA) interconnect, a parallel ATA interconnect, a Fiber Channel interconnect, a USB bus, a Small Computer System Interface (SCSI) interface, or another type of communications medium.

The physical computing device 1000 includes several computer-readable data storage media (i.e., the memory unit 1002, the non-volatile storage device 1010, and the external storage device 1016). Together, these computer-readable storage media may constitute a single data storage system. As discussed above, a data storage system includes a set of one or more computer-readable data storage mediums. This data storage system may store instructions executable by the processing unit 1004. Activities described in the above description may result from the execution of the instructions stored on this data storage system. Thus, when this description says that a particular logical module performs a particular activity, such a statement may be interpreted to mean that instructions of the logical module, when executed by the processing unit 1004, cause the physical computing device 1000 to perform the activity. In other words, when this description says that a particular logical module performs a particular activity, a reader may interpret such a statement to mean that the instructions configure the physical computing device 1000 such that the physical computing device 1000 performs the particular activity.

The techniques of this patent document may be realized in many ways. For example, the techniques of this patent document may be realized as a method for identifying and communicating with experts through a communicator application. The method comprises causing, by a computing device, a display device to display a graphical user interface of the communicator application to a first user of the communicator application. The communicator application is an application that initiates communication sessions between the first user and one or more other users of the communicator application. The method also comprises receiving, by the computing device, search input via the graphical user interface. The search input indicates a type of expertise. In addition, the method comprises causing, by the computing device after receiving the search input, the display device to display a user identifier within the graphical user interface. The user identifier identifies a second user of the communicator application. The second user possesses the type of expertise indicated by the search input.

In another example, the techniques of this patent document may be realized as a computing device comprising a data storage system and a processing unit that executes software instructions stored on the data storage system. Execution of the software instructions causes the computing device to cause a display device to display a graphical user interface of the communicator application to a first user of a communication application, the communicator application being an application that initiates communication sessions between the first user and one or more other users of the communicator application. Furthermore, execution of the software instructions causes the computing device to receive search input from the first user via the graphical user interface. The search input indicating a type of expertise. In addition, execution of the software instructions causes the computing device to cause, after receiving the search input, the display device to display a user identifier within the graphical user interface. The user identifier identifies a second user of the communicator application. The second user possesses the type of expertise indicated by the search input.

In another example, the techniques of this patent document may be realized as a computer-readable medium comprising software instructions that, when executed by a processing unit of a computing device, cause the computing device to retrieve, from a communication server, data representing a buddy list of a first user of a communication application. The communicator application includes an application that initiates real-time communication between the first user and one or more other users of the communicator application. The software instructions, when executed by the processing unit, further cause the computing device to retrieve, from the communication server, presence data for users on the buddy list of the first user. In addition, the software instructions, when executed by the processing unit, cause the computing device to cause a display device to display a graphical user interface of the communicator application to the first user. The graphical user interface including a first set of user identifiers. Each user identifier in the first set of user identifiers identifies a user in a set of users of the communication application. Each user in the first set of users is on the buddy list of the first user. The graphical user interface also includes a first set of availability indicators. Each availability indicator in the first set of availability indicators indicates whether a user in the first set of users is available to begin a communication session. The first set of availability indicators is based on the presence data for users on the buddy list of the first user. The graphical user interface also includes a search box. Furthermore, the software instructions, when executed by the processing unit, cause the computing device to receive search input from the first user via the search box. The search input indicates a type of expertise. In response to receiving the search input, the software instructions, when executed by the processing unit, cause the computing device to identify a user chain that links the first user to a second user of the communicator application, the second user possessing the type of expertise indicated by the search input, the user chain including a set of intervening users, the second user not on the buddy list of the first user. Furthermore, in response to receiving the search input, the software instructions, when executed by the processing unit, cause the computing device to retrieve, from the communication server, presence data for users in the user chain. In addition, in response to receiving the search input, the software instructions, when executed by the processing unit, cause the computing device to retrieve, from the communication server, ratings data for users in the user chain. Moreover, in response to receiving the search input, the software instructions, when executed by the processing unit, cause the computing device to cause the display device to display in a results area of the graphical user interface a second set of user identifiers, each user identifier in the set of user identifiers identifying a user in the user chain. The results area of the graphical user interface also includes a second set of availability indicators. Each availability indicator in the set of availability indicators indicating whether a user in the user chain is available to begin a communication session. The set of availability indicators is based on the presence data for the users in the user chain. The results area of the graphical user interface also includes a set of ratings indicators. Each ratings indicator in the set of ratings indicators indicates a rating of a user in the user chain. The set of ratings indicators is based on the ratings data for the users in the user chain. Furthermore, the software instructions, when executed by the processing unit, cause the computing device to receive an introduction request input via the graphical user interface. The introduction request input indicates to the communicator application that the first user wants the communicator application to send an introduction request to a user in the set of intervening users. The introduction request indicates that the first user wants the user in the set of intervening users to introduce the first user to either another user in the set of intervening users or the second user. In addition, the software instructions, when executed by the processing unit, cause the computing device to receive a group communication request input via the graphical user interface. The group communication request input indicates to the communicator application that the first user wants the communicator application to send an invitation to join a group communication session to at least one user in the set of intervening users and the second user. Furthermore, the software instructions, when executed by the processing unit, cause the computing device to receive feedback input via the graphical user interface. The feedback input indicates how helpful a user in the user chain was to the first user.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A method for identifying and communicating with experts through a communicator application, the method comprising:
causing, by a computing device, a display device to display a graphical user interface of the communicator application to a first user of the communicator application, the communicator application being an application that initiates communication sessions between the first user and one or more other users of the communicator application;
receiving, by the computing device, search input via the graphical user interface, the search input indicating a type of expertise; and
causing, by the computing device after receiving the search input, the display device to display a user identifier within the graphical user interface, the user identifier identifying a second user of the communicator application, the second user possessing the type of expertise indicated by the search input.

2. The method of claim 1, wherein causing the display device to display the graphical user interface comprises:
causing, by the computing device, the display device to display a set of user identifiers within the graphical user interface, each user identifier in the set of user identifiers identifying a user in a set of users of the communication application, each user in the set of users being on a buddy list of the first user; and
causing, by the computing device, the display device to display a set of availability indicators within the graphical user interface, each availability indicator in the set of availability indicators indicating whether a user in the set of users is available to begin a communication session.

3. The method of claim 1, further comprising:
causing, by the computing device, the display device to display within the graphical user interface user identifiers that identify users of the communication application in a user chain that links the first user and the second user; and
causing, by the computing device, the display device to display a set of availability indicators within the graphical user interface, each availability indicator in the set of availability indicators indicating whether a user in the user chain is available to begin a communication session.

4. The method of claim 3, wherein the user chain includes an intervening user set that includes at least one intervening user.

5. The method of claim 4, further comprising: receiving, by the computing device, an introduction request input via the graphical user interface, the introduction request input indicating to the communicator application that the first user wants the communicator application to send an introduction request to a user in the intervening user set, the introduction request indicating that the first user wants the user in the intervening user set to introduce the first user to either another user in the intervening user set or the second user.

6. The method of claim 4, further comprising: receiving, by the computing device, a group communication request input via the graphical user interface, the group communication request input indicating to the communicator application that the first user wants the communicator application to send an invitation to join a group communication session to at least one user in the intervening user set and the second user.

7. The method of claim 3, further comprising: receiving, by the computing device, communication initiation input via the graphical user interface, the communication initiation input indicating a desire by the first user to initiate a communication session between the first user and a user in the user chain.

8. The method of claim 7, wherein the communication session is one of the following types of communication session: an instant message communication session, a voice communication session, a web meeting, a chat room session, and a video communication session.

9. The method of claim 3, wherein causing the display device to display the graphical user interface comprises: causing, by the computing device, the display device to display within the graphical user interface a rating indicator associated with a user in the user chain.

10. The method of claim 9, wherein the method further comprises: receiving, by the computing device, feedback input via the graphical user interface, the feedback input indicating how helpful the second user was to the first user.

11. The method of claim 3, further comprising: identifying, by the computing device, the user chain that links the first user and the second user.

12. The method of claim 11, wherein identifying the user chain comprises:
receiving, by the computing device, data from a server, the data identifying users possessing the type of expertise indicated by the search input; and
determining, by the computing device, whether a buddy list of the first user includes any of the users possessing the type of expertise indicated by the search input.

13. The method of claim 12, wherein identifying the user chain further comprises: determining, by the computing device, whether a second buddy list includes any of the users possessing the type of expertise indicated by the search input, the second buddy list being a buddy list of a user on the buddy list of the first user.

14. The method of claim 1,
wherein causing the display device to display the graphical user interface comprises: sending, by the computing device, interface data to a client device via an electronic communications network, a web browser application at the client device causing the client device to use the interface data to render the graphical user interface on the display device; and
wherein receiving the search input comprises: receiving, by the computing device, the search input from the client device.

15. A computing device comprising:
a data storage system; and
a processing unit that executes software instructions stored on the data storage system, execution of the software instructions causing the computing device to:
cause a display device to display a graphical user interface of the communicator application to a first user of a communication application, the communicator application including an application that initiates communication sessions between the first user and one or more other users of the communicator application;
receive search input from the first user via the graphical user interface, the search input indicating a type of expertise; and
cause, after receiving the search input, the display device to display a user identifier within the graphical user interface, the user identifier identifying a second user of the communicator application, the second user possessing the type of expertise indicated by the search input.

16. The computing device of claim 15, wherein the software instructions, when executed by the processing unit, further cause the computing device to:
cause the display device to display within the graphical user interface user identifiers that identify users of the communicator application in a user chain that links the first user and the second user; and
cause the display device to display a set of availability indicators within the graphical user interface, each availability indicator in the set of availability indicators indicating whether a user in the user chain is available to begin a communication session,
wherein the user chain includes an intervening user set that includes at least one intervening user.

17. The computing device of claim 16, wherein the software instructions that, when executed by processing unit, cause the computing device to display the graphical user interface comprise software instructions that, when executed by the processing unit, cause the computing device to: cause the display device to display within the graphical user interface rating indicators associated with each user in the user chain.

18. The computing device of claim 16, wherein the software instructions, when executed by the processing unit, further cause the computing device to receive an introduction request input via the graphical user interface, the introduction request input indicating to the communicator application that the first user wants the communicator application to send an introduction request to a user in the intervening user set, the introduction request indicating that the first user wants the user in the intervening user set to introduce the first user to either another user in the intervening user set or the second user.

19. The computing device of claim 16, wherein the software instructions, when executed by the processing unit, further cause the computing device to receive a group communication request input via the graphical user interface, the group communication request input indicating to the communicator application that the first user wants the communicator application to send an invitation to join a group communication session to at least one user in the intervening user set and the second user.

20. A computer-readable medium comprising software instructions that, when executed by a processing unit of a computing device, cause the computing device to:
retrieve, from a communication server, data representing a buddy list of a first user of a communication application, the communicator application being an application that initiates real-time communication between the first user and one or more other users of the communicator application;
retrieve, from the communication server, presence data for users on the buddy list of the first user;
cause a display device to display a graphical user interface of the communicator application to the first user, the graphical user interface including:
a first set of user identifiers, each user identifier in the first set of user identifiers identifying a user in a set of users of the communication application, each user in the first set of users being on the buddy list of the first user, and
a first set of availability indicators, each availability indicator in the first set of availability indicators indicating whether a user in the first set of users is available to begin a communication session, the first set of availability indicators based on the presence data for users on the buddy list of the first user, and
a search box;
receive search input from the first user via the search box, the search input indicating a type of expertise;
in response to receiving the search input:
identify a user chain that links the first user to a second user of the communicator application, the second user possessing the type of expertise indicated by the search input, the user chain including a set of intervening users, the second user not on the buddy list of the first user;
retrieve, from the communication server, presence data for users in the user chain;
retrieve, from the communication server, ratings data for users in the user chain;
cause the display device to display in a results area of the graphical user interface:
a second set of user identifiers, each user identifier in the set of user identifiers identifying a user in the user chain,
a second set of availability indicators, each availability indicator in the set of availability indicators indicating whether a user in the user chain is available to begin a communication session, the set of availability indicators based on the presence data for the users in the user chain,
a set of ratings indicators, each ratings indicator in the set of ratings indicators indicating a rating of a user in the user chain, the set of ratings indicators based on the ratings data for the users in the user chain;
receive an introduction request input via the graphical user interface, the introduction request input indicating to the communicator application that the first user wants the communicator application to send an introduction request to a user in the set of intervening users, the introduction request indicating that the first user wants the user in the set of intervening users to introduce the first user to either another user in the set of intervening users or the second user;
receive a group communication request input via the graphical user interface, the group communication request input indicating to the communicator application that the first user wants the communicator application to send an invitation to join a group communication session to at least one user in the set of intervening users and the second user;
receive feedback input via the graphical user interface, the feedback input indicating how helpful a user in the user chain was to the first user.
